(19) United States
(12) Patent Application Publication
(10) Pub. No.: US 2004/0267508 A1
(43) Pub. Date: Dec. 30, 2004

(54) Computer numerical control code-simulating system and method

(75) Inventors: Kuo-Jung Huang, Tu-Cheng (TW); Chung-Shan Cheng, Tu-Cheng (TW); Ze-Jun Dai, Shenzhen (CN); Xiao-Bing Gao, Shenzhen (CN); Jin-Song Li, Shenzhen (CN); Zhi-Hui Wang, Shenzhen (CN); Wei Shao, Shenzhen (CN); Sheng-Zhong Yi, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/891,948

(22) Filed: Jul. 15, 2004

(30) Foreign Application Priority Data
Jun. 8, 2003 (TW) 92121564

(51) Int. Cl. G06G 7/48

(52) U.S. Cl. 703/7

(57) ABSTRACT

A computer numerical control (CNC) code-simulating system includes a number of client computers (6), a server (1), and a database (2). The database stores all information used and generated by the system. The client computers provide user interfaces enabling users to timely view information on machining of workpieces. The server is connected to a production management system (5), and is used for: obtaining turret information and machining paths of tools from the database; generating CNC code files according to the turret information and the machining paths of tools; constructing figurations of the tools according to parameters of the tools recorded in the CNC code files; simulating machining of the workpieces according to the figurations, the machining paths and of the tools and the turret information; and exporting relevant production management information to the production management system to generate statements for controlling of machining processes. A related method is also disclosed.

### BACKGROUND OF THE INVENTION

1. Field of the Invention

The present invention relates to computer-aided manufacturing systems and methods, and particularly to a computer numerical control (CNC) code-simulating system and method.

2. Related Art of the Invention

With the ongoing globalization of commerce, market competition between modern international corporations is becoming more and more intense. In particular, international manufacturing corporations have to try their best to improve their competitiveness. Improving production efficiency is a never-ending challenge. Improvements in machine punching tool hardware and falling commodity prices have helped increase many corporations' efficiency. Further, the use of computers to automate manufacturing has become popular, and has improved the speed and quality of sheet-metal punching. Sheet-metal punching at the present time mostly uses CAD (Computer Aided Design) to form 3-dimensional models and define workpieces, and generate manufacturing paths and codes. Those codes are sent to machining centers to guide machining of parts.

There is a notable problem with automated sheet-metal punching at the present time; namely, codes are directly sent to machining centers to guide machining of parts without simulating machining in advance. If the codes are faulty, defective products are likely to be manufactured.

There is a need for an apparatus and method which can overcome the abovementioned problems and reduce error rates of codes.

### SUMMARY OF THE INVENTION

Accordingly, a main objective of the present invention is to provide a computer numerical control (CNC) code-simulating system and method, which can generate CNC code files, simulate machining of workpieces, and generate statements for control of machining processes.

To accomplish the above objective, a CNC code-simulating system in accordance with a preferred embodiment of the present invention includes a plurality of client computers, a database and a server. The database stores information including turret information, tool information, machining paths of tools on each turret, CNC code files, ISO (International Standards Organization) standards for CNC codes, and materials of workpieces. The client computers can access the server via a network to timely obtain information on machining of the workpieces. The server includes: a CNC code generating module for generating CNC code files according to the turret information and the machining paths of tools on each turret; a machining simulating module for constructing figurations of the tools according to parameters of the tools recorded in the CNC code files, and for simulating machining of the workpieces according to the figurations, the machining paths and a machining sequence of the tools; a tool analyzing module for searching in the database for corresponding tool information according to the parameters of the tools recorded in the CNC code files, and for modifying the parameters of the tools when no corresponding tool information exists in the database; a CNC code analyzing module for determining whether all the CNC codes in the CNC code files are correct according to the ISO standards, and for modifying any incorrect CNC codes; and a production management module for exporting CNC code files, types of machines and materials of the workpieces to a production management system. The production management system then calculates usage rates of materials and machining times for workpieces, and generates a statement for controlling of the machining process.

Further, the present invention provides a CNC code-simulating method, the method comprising the steps of: (a) obtaining information on a turret (“turret information”) and machining paths of tools on the turret from a database; (b) generating a CNC code file according to the turret information and the machining paths of tools on the turret; (c) constructing figurations of the tools according to parameters of the tools recorded in the CNC code file; (d) simulating machining of workpieces according to the figurations, the machining paths and a machining sequence of the tools; (e) searching in the database for corresponding tool information according to the parameters of the tools recorded in the CNC code file; (f) modifying the parameters of the tools, if no corresponding tool information exists in the database; (g) determining whether all the CNC codes in the CNC code file are correct according to ISO standards for the CNC codes, and modifying any incorrect CNC codes, if any corresponding tool information exists in the database; and (h) exporting relevant production management information to a production management system.

Other objects, advantages and novel features of the present invention will be drawn from the following detailed description with reference to the attached drawings, in which:

### BRIEF DESCRIPTION OF THE DRAWINGS

FIG. 1 is a schematic diagram of hardware infrastructure of a CNC code-simulating system in accordance with the preferred embodiment of the present invention;

FIG. 2 is a schematic diagram of main function modules of a server of the CNC code-simulating system of FIG. 1;

FIG. 3 is a flowchart of a preferred method for implementing the CNC code-simulating system of the present invention; and

FIG. 4 is a flowchart of a preferred method for implementing one step of FIG. 3, namely constructing figurations of tools and simulating machining of workpieces according to a CNC code file.

### DETAILED DESCRIPTION OF THE INVENTION

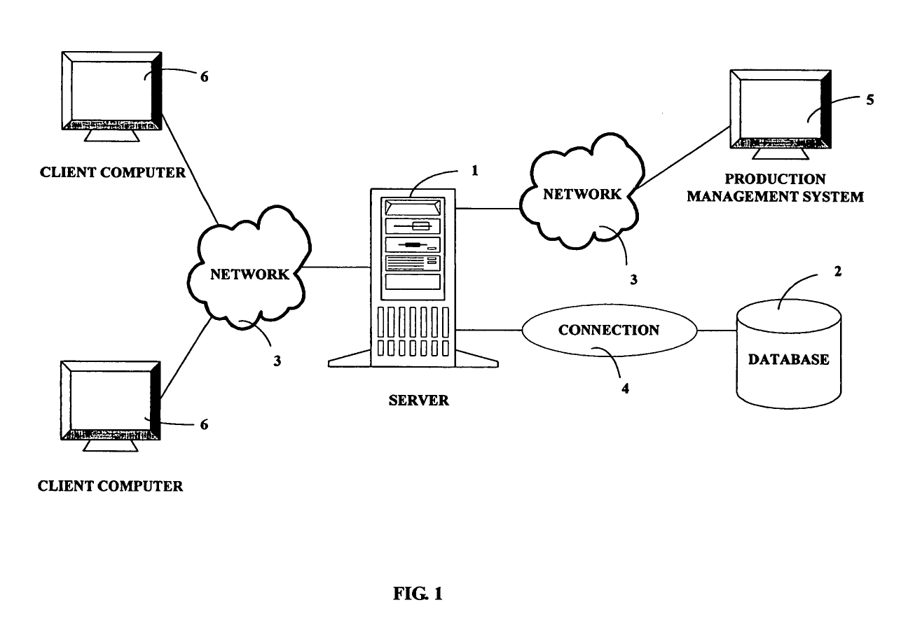

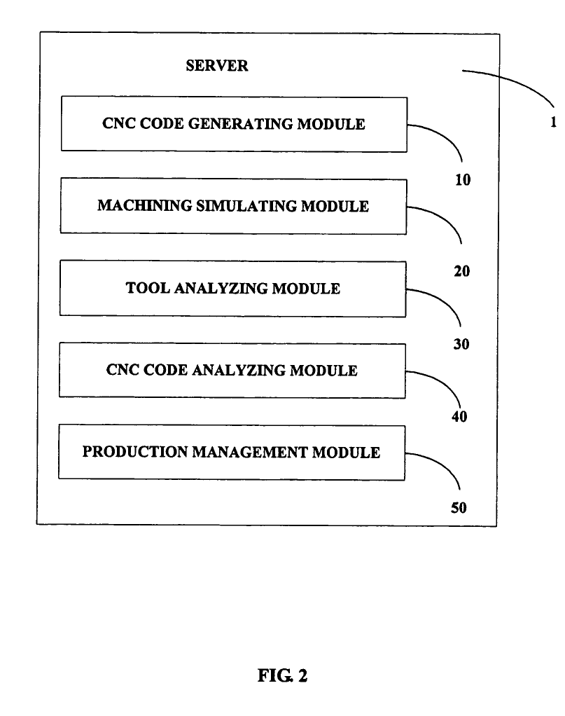

FIG. 1 is a schematic diagram of hardware infrastructure of a CNC code simulating system (“the system”) in accordance with the preferred embodiment of the present invention. The system comprises a plurality of client computers 6 (only two shown), a server 1, and a database 2. The client computers 6 communicate with the server 1 through a network 3. The server 1 is connected to the database 2 through a connection 4. The network 3 may be any suitable communication architecture required by the system, such as a local area network or a wide area network. The connection 4 is a database connectivity such as an Open Database Connectivity (ODBC) or a Java Database Connectivity (JDBC). The client computers 6 provide user interfaces enabling users to timely view information on machining of workpieces obtained from the server 1. The database 2 stores information including turret information, tool information, machining paths of tools on each turret, CNC codes, ISO standards for the CNC codes, types of machines which are used for machining workpieces, and materials of the workpieces. The turret information includes parameters and a machining sequence of various tools on each turret, and sizes and distributions of tool stations on the turret. The server 1 is connected to a production management system 5 through the network 3. The server 1 comprises a plurality of function modules (described in detail below in relation to FIG. 2), and is used for: obtaining turret information and machining paths of tools on each turret, and generating CNC code files according to the turret information and the machining paths of tools; simulating machining of workpieces according to the CNC code files; and exporting relevant production management information including CNC code files, types of machines which are used for machining the workpieces and materials of the workpieces to the production management system 5. The production management system 5 calculates usage rates of materials and a machining time for each workpiece, and generates a statement recording the usage rates of materials and machining times of all the workpieces. The statement facilitates control of the machining process.

FIG. 2 is a schematic diagram of main function modules of the server 1. The server 1 comprises a CNC code generating module 10, a machining simulating module 20, a tool analyzing module 30, a CNC code analyzing module 40, and a production management module 50. The CNC code generating module 10 is used for generating CNC code files according to the turret information and machining paths of tools on each turret stored in the database 2. The machining simulating module 20 is used for constructing figurations of the tools according to the parameters of the tools recorded in a corresponding CNC code file, and for simulating machining of the workpieces according to the figurations, the machining paths and the machining sequence of the tools. According to the preferred embodiment of the present invention, the machining paths of tools mean the route each tool takes when machining a workpiece, and the machining sequence of the tools means the sequence in which tools on each turret are used to machine a workpiece. The tool analyzing module 30 is used for searching in the database 2 for corresponding tool information according to the parameters of the tools recorded in the CNC code files, and for modifying the parameters of the tools if no corresponding tool information exists in the database 2. The CNC code analyzing module 40 is used for determining whether all the CNC codes in the CNC code files are correct according to the ISO standards, and for modifying any incorrect CNC code files. The production management module 50 is used for exporting relevant production management information including CNC code files, types of the machines which are used for machining the workpieces and materials of the workpieces to the production management system 5. The production management system 5 then calculates usage rates of the materials and machining times for the workpieces, and generates a corresponding statement for controlling of the machining process.

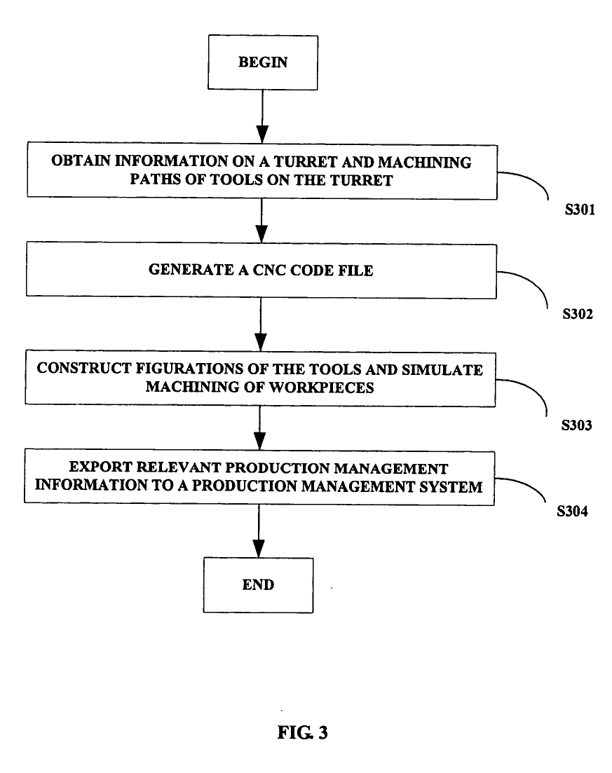

FIG. 3 is a flowchart of a preferred method for implementing the CNC code-simulating system of the present invention. In step S301, the CNC code generating module 10 obtains information on a turret (“turret information”) and machining paths of tools on the turret from the database 2. In step S302, the CNC code generating module 10 generates a CNC code file according to the turret information and the machining paths of tools on the turret. In step S303, the machining simulating module 20 constructs figurations of the tools according to parameters of the tools recorded in the CNC code file, and simulates machining of workpieces according to the figurations, the machining paths and machining sequence of the tools. In step S304, the production management module 50 exports relevant production management information including the CNC code file, types of the machines which are used for machining the workpieces and the materials of the workpieces to the production management system 5. The production management system 5 calculates usage rates of the materials and machining times for the workpieces, and generates a corresponding statement for controlling of the machining process.

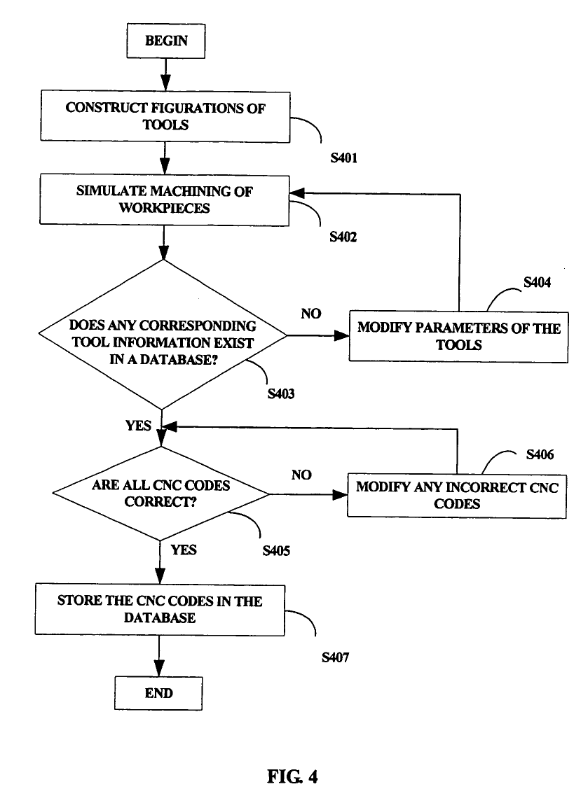

FIG. 4 is a flowchart of a preferred method for implementing step S303 of FIG. 3, namely constructing figurations of the tools and simulating machining of workpieces according to a generated CNC code file. In step S401, the machining simulating module 20 constructs figurations of the tools according to the parameters of the tools recorded in the CNC code file. In step S402, the machining simulating module 20 simulates the machining of the workpieces according to the figurations, the machining paths and the machining sequence of the tools. In step S403, the tool analyzing module 30 searches in the database 2 for corresponding tool information according to the parameters of the tools recorded in the CNC code file, and determines whether any corresponding tool information exists in the database 2. If no corresponding tool information exists in the database 2, in step S404, the tool analyzing module 30 modifies the parameters of the tools recorded in the CNC code file, whereupon the procedure returns to step S402 described above. If any corresponding tool information exists in the database 2, in step S405, the CNC code analyzing module 40 determines whether all the CNC codes in the CNC code file are correct according to ISO standards for the CNC codes. If any CNC codes are incorrect, in step S406, the CNC code analyzing module 30 modifies the incorrect CNC codes, whereupon the procedure returns to step S405 described above. If and when all the CNC codes are correct, in step S407, the CNC code analyzing module 30 stores the CNC code file in the database 2.

Although the present invention has been specifically described on the basis of a preferred embodiment and preferred methods, the invention is not to be construed as being limited thereto. Various changes and modifications may be made to the embodiment and methods without departing from the scope and spirit of the invention.

What is claimed is:

1. A CNC (computer numerical control) code-simulating system, comprising:
a database for storing information including turret information, tool information, machining paths of tools, CNC codes, ISO (International Standards Organization) standards for the CNC codes, and materials of workpieces, wherein the turret information comprises a sequence of tools on each turret; and
a server comprising:
a CNC code generating module for generating CNC code files according to the turret information and machining paths of tools on each turret;
a machining simulating module for constructing figurations of tools according to parameters of the tools recorded in the CNC code files, and simulating machining of workpieces according to the figurations, the machining paths and the machining sequence of the tools;
a tool analyzing module for searching in the database for corresponding tool information according to the parameters of the tools recorded in the CNC code files; and
a CNC code analyzing module for determining whether all the CNC codes in the CNC code files are correct according to the ISO standards for the CNC codes, and for modifying any incorrect CNC codes.

2. The CNC code-simulating system according to claim 1, wherein the system is adapted to be connected to a production management system via a network.

3. The CNC code-simulating system according to claim 2, wherein the production management system is used for calculating usage rates of the materials and machining times for the workpieces, and generating statements for controlling of machining processes.

4. The CNC code-simulating system according to claim 2, wherein the server further comprises a production management module for exporting information including CNC code files, types of machines and materials of the workpieces to the production management system in order to have a statement for controlling of a machining process generated.

5. The CNC code-simulating system according to claim 1, wherein the tool analyzing module is further used for modifying the parameters of the tools recorded in the CNC code files if no corresponding tool information exists in the database.

6. A CNC (computer numerical control) code-simulating method, comprising the steps of:
obtaining information on a turret (“turret information”) and machining paths of tools on the turret;
generating a CNC code file according to the turret information and the machining paths of tools on the turret;
constructing figurations of the tools according to parameters of the tools recorded in the CNC code file;
simulating machining of workpieces according to the figurations, the machining paths and the machining sequence of the tools;
searching in a database for corresponding tool information according to the parameters of the tools recorded in the CNC code file;
modifying the parameters of the tools if no corresponding tool information exists in the database;
determining whether all the CNC codes in the CNC code file are correct if any corresponding tool information exists in the database; and
modifying any incorrect CNC codes.

7. The method according to claim 6, further comprising the step of returning to the step of simulating machining of workpieces after performing the step of modifying the parameters of the tools.

8. The method according to claim 6, further comprising the step of returning to the step of determining the correctness of the CNC codes after performing the step of modifying any incorrect CNC codes.

9. The method according to claim 6, further comprising the step of storing the CNC code file in the database if all the CNC codes in the CNC code file are correct.

10. The method according to claim 6, further comprising the step of exporting information including CNC codes, types of machines which are used for machining the workpieces and materials of the workpieces to a production management system in order to have a statement for controlling of a machining process generated.
